(19) United States
(12) Patent Application Publication
(10) Pub. No.: US 2005/0004867 A1
(43) Pub. Date: Jan. 6, 2005

(54) Network-based donation management system

(76) Inventor: Eric Mason Spector, Kensington, CA (US)

Correspondence Address: SHUMAKER & SIEFFERT, P. A., 8425 SEASONS PARKWAY, SUITE 105, ST. PAUL, MN, 55125, US

(21) Appl. No.: 10/847,889

(22) Filed: May 17, 2004

Related U.S. Application Data
(60) Provisional application No. 60/471,198, filed on May 16, 2003.

(51) Int. Cl. G06F 17/60

(52) U.S. Cl. 705/39; 705/38

(57) ABSTRACT

Techniques for network-based management and tracking of donations and associated donation information are described. More specifically, a donation management system is described that comprises a group manager module and a donation manager module. The group manager module presents a user interface with which a donor interacts to create a private donation group. Donors may join the private donation group by invitation only and the private donation group generally limits non-member donors from viewing information regarding the private donation group. The donation manager module receives electronic donations from members of the private donation group via a computer network. As such, the donation management system provides a comprehensive and adaptive approach to managing donations in a secure and private manner.

This application claims priority from U.S. Provisional Application Ser. No. 60/471,198, filed May 16, 2003, the entire content of which is incorporated herein by reference.

### TECHNICAL FIELD

The invention generally relates to computer-based donation management systems for capturing, managing and tracking donations to organizations.

### BACKGROUND

Nonprofit organizations, such as charities, may be partially funded by donations from donors within a community. Often, nonprofit organizations solicit donations through events, such as walk-a-thons, auctions, and baked good sales, as well as through advertising, direct mail solicitations, emails, online newsletters or outbound telephone calls with asks for funds, and public endorsements. A donor may participate in an event, respond to a direct mail, email or telephone ask, or contact the nonprofit organization to make a donation to the nonprofit organization.

Upon receiving a donation, the nonprofit organization tracks the donation by detailing the donor's name, address, payment method, donation amount, and other such donation information (e.g. credit card number and expiration date, if donation is charged to a credit card). This donation information is required to properly maintain income tax records and the nonprofit status of the organization. Furthermore, a donor may request the donation information for tax purposes. The tracking and managing of donations and associated donation information is a time-consuming process. Moreover, frequent requests for donation information by donors may result in further time costs for the nonprofit organization.

To reduce these time costs and better leverage past donors for future requests, donation management systems automate portions of the donation tracking and managing process. A donation management system typically operates through an Internet-based user interface, such as a web browser, and provides an automated process for donating to a nonprofit organization. Generally, a donor interacts with the donation management system to make individual donations. For event-driven fundraising, a donor may either form or join an existing donation group of one or more donors that donate money to a particular nonprofit organization. The donation management system may log all donations as well as associated donation information by other group members and provide this information to donors through interactions with the donation management system. Thus, the donation management system greatly reduces time costs associated with managing and tracking donations and provides motivating recognition to supporting donors.

While reducing time costs facilitates donation management, some nonprofit organizations may not be able to integrate with the donation management systems. In particular, donation management systems may not be flexible enough to suit the needs of some nonprofit organizations and/or donors. For example, most group oriented donation management systems are event driven, i.e., formation of donation groups for an event and termination of the donation groups after the event ends. However some nonprofit organizations do not solicit donations through events, and such approaches do not leverage the appeal of groups of friends, co-workers, and family to support a cause or program that is not tied to a fundraising event. Furthermore, donation management systems typically only provide public donation groups, i.e., donation groups that are open to the public, yet some donors may not want the entire public to join or have viewing access to members or donations made by their donation group.

### SUMMARY

In general, the invention is directed to techniques for network-based management and tracking of donations and associated donation information. More specifically, an online donation management system is described that presents a user interface and turnkey back-end system with which organizations interact to create on online presence for the solicitation of donations by grouping of donors wishing to support one or more of the organization's designated programs or causes. Via the user interface, donors interact with the online donation management system to establish groups and/or join established donation groups. Individual groups may be defined as either public or private (i.e. closed to the public and possibly requiring an invitation to join).

The donation management system may allow donors to establish different types of charitable programs, including those that are not event driven. For example, the donation management system allows charitable organizations to define programs that accept donations over a time period or in an ongoing manner. For example, an organization can define a continuing program that accepts donations year-round, and the online donation management system may be configured to automatically send renewal notices in order to maintain donations from year-to-year. The online donation management system also permits donations of any amount above a designated minimum to be made and credited both to the individual donor and the group as a whole. Furthermore, the donation management system provides complete online financial reporting of total contributions resulting from each donor, including both individual donations made by each donor, and donations resulting from invitations sent by donors to friends and family that then result in additional third-part donations. Displaying the contribution totals produces competition between donors within the same donation group and between donation groups. Moreover, the display of the contribution total provides real-time recognition for each donor's individual giving and the outreach efforts of each group member/donor sending invitations to others. The real-time displaying of contribution totals also eliminates the need to print costly year-end contribution books.

In one embodiment, the invention is directed to a method for providing network-based management of donations. The method comprises presenting a user interface to receive input to create a private donation group and receiving electronic donations to the private donation group via a computer network.

In another embodiment, the invention is directed to a method for providing network-based management of donations. The method comprises presenting a user interface to specify a paying donor that makes electronic donations on behalf of an associate donor and receiving the electronic donations from the paying donor on behalf of the associate donor via a computer network.

In another embodiment, the invention is directed to a method for providing network-based management of donations. The method comprises maintaining a database defining a plurality of donors and a plurality of donation intervals over a time period, presenting a user interface to associate at least one of the plurality of donors with each of the plurality of donation intervals, and receiving electronic donations from each of the plurality of donors at the donation interval associated with the respective donor.

In another embodiment, the invention is directed to a method for providing network-based management of donations. The method comprises maintaining a database defining an organization that includes a plurality of programs, presenting a user interface to specify one or more of the plurality of programs as beneficiaries of a donation group, and receiving electronic donations to the one or more specified programs from donors that are members of the donation group via a computer network.

In another embodiment, the invention is directed to a donation management system. The system comprises a donor manager module to present a user interface to specify a paying donor that makes electronic donations on behalf of an associate donor and a donation manager module to receive the electronic donations from the paying donor on behalf of the associate donor via a computer network.

In another embodiment, the invention is directed to a donation management system. The system comprises one or more databases to define a donation group that includes one or more donors, wherein the database stores invite data for each donor specifying a total dollar amount donated by one or more other donors in response to an electronic invitation by the donor, and a group manager module to present a user interface to display the invite data for each of the donors of the donation group.

In another embodiment, the invention is directed to a donation management system. The system comprises one or more databases to define a plurality of donors and a plurality of donation intervals over a time period and a donor manager module to present a user interface to associate at least one of the plurality of donors with each of the plurality of donation intervals. The system further comprises a donation manager module to receive electronic donations from each of the plurality of donors at the donation interval associated with the respective donor.

In another embodiment, the invention is directed to a donation management system. The system comprises a database defining an organization that includes a plurality of programs and a group manager module to present a user interface to specify one or more of the plurality of programs as beneficiaries of a donation group. The system further comprises a donation manager module to receive electronic donations to the one or more specified programs from donors that are members of the donation group via a computer network.

In another embodiment, the invention is directed to an online donation management system. The system comprises a web server that includes user interface modules that present user interfaces with which a plurality of organizations interact to solicit donations by creating one or more programs and with which a plurality of donors interact to create donation groups, wherein the donation groups include at least one private donation group. The system further comprises a database server that includes databases to store information associated with the programs and donation groups.

In another embodiment, the invention is directed to a computer-readable medium for providing network-based management of donations. The computer-readable medium contains instructions for causing a programmable processor to present a user interface to receive input to create a private donation group and receive electronic donations to the private donation group via a computer network.

The invention may be capable of providing one or more advantages. For example, the donation management system provides a secure user interface for donating to one or more donation groups on a year-round basis. Furthermore, the management system allows the set-up of public and private donation groups. A private donation group provides a way for families, churches, organizations, and the like to easily contribute to a specific charity as a group and retain control over who is permitted to join the group. In addition, the donation groups allow several donors to share a giving commitment that may be difficult for a single donor to meet.

The details of one or more embodiments of the invention are set forth in the accompanying drawings and the description below. Other features and advantages of the invention will be apparent from the description and drawings, and from the claims.

### BRIEF DESCRIPTION OF DRAWINGS

FIG. 1 is a block diagram illustrating an exemplary network-based environment in which a donation management system provides network-based management and tracking of donations.

FIG. 2 is a block diagram illustrating an example embodiment of a donation management system with which an organization interacts to solicit donations and a donor interacts to establish and/or join groups to make donations to programs defined by organization.

FIG. 3 is an example web-based user interface presented by an organization manager to set-up a program within an organization.

FIG. 4 is an example web-based user interface presented by a group manager to receive a selection to either join a donation group or start a donation group.

FIG. 5 is an example web-based user interface presented by a group manager in response to receiving a selection to start a donation group.

FIG. 6 is an example web-based user interface presented by a group manager to receive a program selection.

FIG. 7 is an example web-based user interface presented by a group manager to display information about a donation group.

FIG. 8 is an example web-based user interface presented by a group manager to display donor contributions and invite data representing contributions resulting from electronic invitations sent by the donors.

FIG. 9 is an example web-based user interface presented by a template manager in to invite a new donor.

FIG. 10 is an example electronic invitation sent by a donation management system to request a donation on behalf of a donor.

FIG. 11 is another example electronic invitation sent by a donation management system in response to a donor selecting to make payments on behalf of another donor.

FIG. 12 is a web-based user interface presented by a donor manager in response to a donor accepting donations made on the donor's behalf.

FIG. 13 is a web-based user interface presented by a group manager to enable donors to search for a public group.

FIG. 14 is a flowchart illustrating exemplary operation of a donation management system in providing user interfaces to add programs.

FIG. 15 is a flowchart illustrating exemplary operation of a donation management system in providing a user interface to create a private group.

FIG. 16 is an exemplary web-based user interface presented by a group manager to organize monthly contributions within a donation group.

FIG. 17 is an exemplary newsletter or update that a donor may receive from a donation management system.

### DETAILED DESCRIPTION

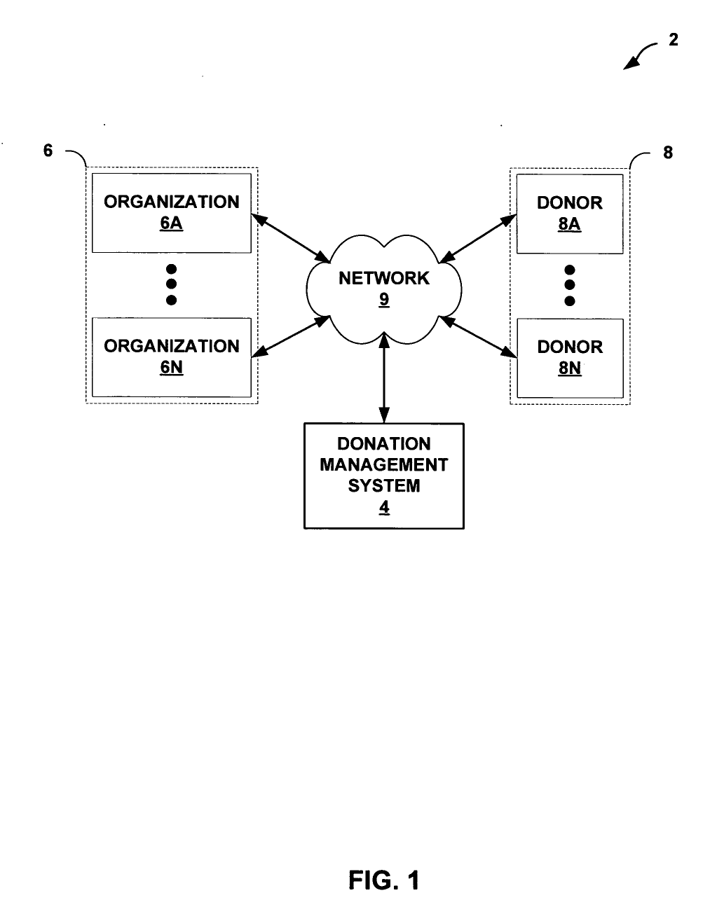

FIG. 1 is a block diagram illustrating an exemplary network-based environment 2 in which a donation management system 4 provides network-based management and tracking of donations. As described in detail herein, donation management system 4 provides a user interface with which organizations 6A-6N (collectively, “organizations 6”) and donors 8A-8N (collectively, “donors 8”) interact with the system to solicit donations and establish and/or join donation groups, respectively. An organization 6 may be, for example, any one of a university, a school, a church, a charity, a hospital, an association or other charitable organization. As used herein, the term “donations” refers to both electronic donations and donations received by other non-electronic methods.

Donation management system 4 presents the user interface as a graphical set of interrelated screens. Through interactions with these screens, organization 6 may establish one or more programs that can receive donations from one or more of donors 8. Donors 8 interact with the screens to create one or more groups that designate one or more of the programs as a beneficiary of the donations made by member donors of these one or more groups.

In general, donors 8 may create private or public groups. A private group does not allow the public, i.e., non-members, access to content, such as websites, some of the donation information, and member list, provided by the private group. To become a member of a private group, a non-member must receive and accept an invitation from a current member. A public group, however, allows any member to join and may not require an invitation to join. Typically, the public, i.e., non-members, may access content, such as websites, some of the donation information, and member list, provided by the public groups. Both public and private groups may last until the founding members terminate the groups and may not be based on events, i.e., may extend beyond events and continue year after year. While many of the techniques are generally discussed in the context of private groups, the techniques may readily be applied to both private and public groups.

Once one of donors 8 creates a group, the group founder may use tools provided by donor management system 4 to inform other non-members of donors 8 of the new group. For example, donor management system 4 provides tools to tell a friend about the group, such as tools to customize electronic mail templates, and newsletters, and other tools to invite a friend, such as tools to customize electronic invitations. Further, donation management system 4 may provide group founders with tools to customize a group website as well as tools that allow donors 8 to search for a group among the many groups that donation management system 4 may host.

Once one of donors 8 becomes a member of a group, the group member may schedule donations via interactions with the screens. Donor management system 4 handles all donations securely and confidentially and securely logs all data entered by the group member. Donor management system 4 may provide a process for making a donation on behalf of another person. For example, one of donors 8 may be unable to make a donation due to age requirements or the lack of a payment mechanism such as a credit card. In this situation, donor management system 4 allows another of donors 8 to make a donation on behalf of the underage one of donors 8. Donor management system 4 distributes finds associated with the electronic donations to the charitable organizations 6. Donor management system 4 may distribute the funds electronically, i.e., via electronic transfer, or manually, depending on the capabilities of the particular organization.

In this manner, donation management system 4 provides for comprehensive donation management by allowing donors 8 to establish both public and private groups, by providing tools to inform other donors, and by providing tailored donation processes. Moreover, donation management system 4 may not be strictly event driven, and may provide group management until the founding member terminates the group. Furthermore, donation management system 4 may provide accurate, secure and confidential accounting of all donations made by donors 8. Thus, organizations 6 and donors 8 may access donation management system 4 at any time to view donation information specific to the individual organization or donor. Organization specific donation information may include total donation amount for the organization, date and time of donations, donor name, amount of donation, and the like. Donor specific donation information may include total donation amount by the donor, total donation amount invited by the donor, date and time of donations, billing information, e.g., credit card number, and billing address, and the like.

While donation management system 4 is generally discussed herein in reference to charitable organizations and associated programs of the organizations, the techniques described herein may be used to provide consumer groups and/or individuals the ability to solicit donations. For example, in some embodiments, donation management system 4 may provide user interfaces that allow an individual to establish a group that honors another individual, such as a family member. For example, an individual may interact with donation management system 4 to form a group to honor a recently deceased parent, an anniversary or birthday of another, or the like. In these embodiments, the founding member may specify a charity to which donations are made in honor of the family member. Donation management system 4 may also provide user interfaces to allow members of the honor group to upload electronic content (e.g., photos, captions, anecdotes, and the like) and participate in a forum-like environment to honor the memory of the honored individual.

Organization 6 and donors 8 may access donation management system 4 via network 9 using remote computing devices having suitable communication software, e.g., web browsers. An organization 6 or donor 8 may access donation management system 4 using a network-enabled computing device, such as a workstation, personal computer, laptop computer, web-connected TV or a personal digital assistant (PDA). The communication device executes communication software, such as a web browser, in order to communicate with donation management system 4.

Although discussed herein with respect to a comprehensive online donation management system, the techniques may be applied within a single organization, e.g., corporation. A corporation, for example, may internally deploy a donation management system 4 to allow groups within corporations to be established and donate to one or more defined programs. In these and other embodiment, donor management system may automatically allow for matching donations by the corporations for individual donations made by the employees of the corporation. Thus, donation management system 4 may store information regarding organizational donations as well as information regarding donations made by the employees. Donation management system 4 may provide user interfaces that display donations made by the corporation on behalf of the employees, as well as donations made by employees and other such donation data.

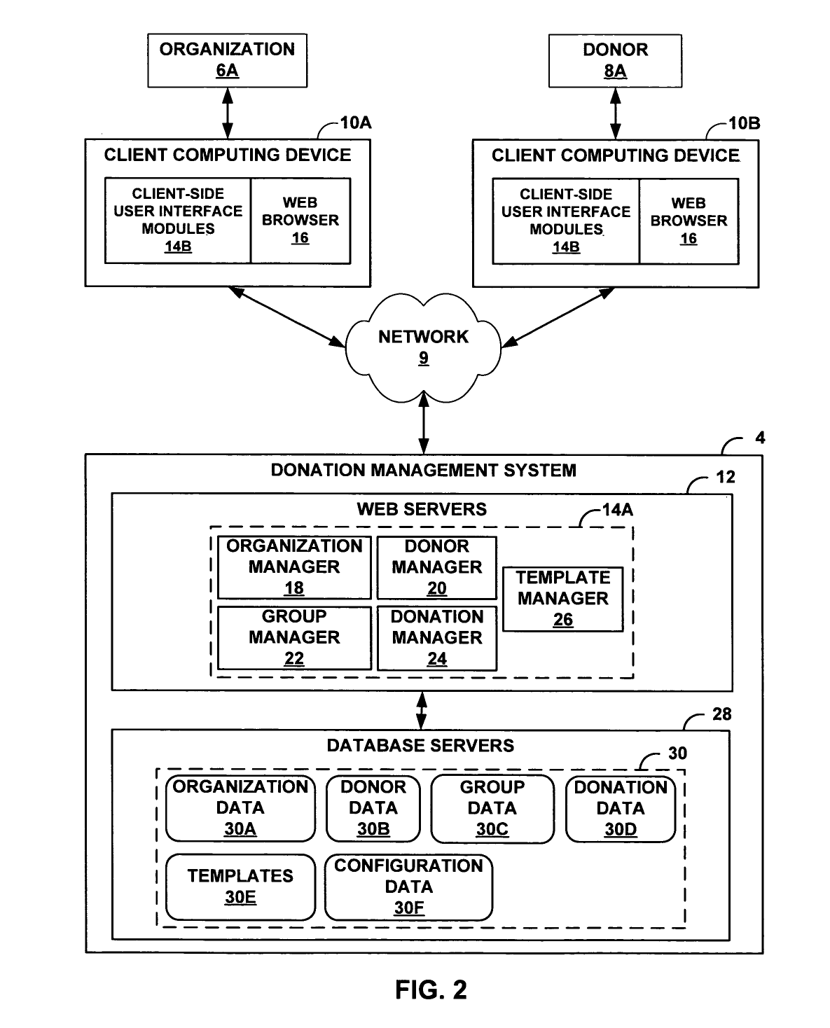

FIG. 2 is a block diagram illustrating an example embodiment of donation management system 4 with which an organization 6A interacts to solicit donations and donor 8A interacts to establish and/or join groups that make donations to programs defined by organization 6A. As shown in FIG. 2, organization 6A and donor 8A remotely access donation management system 4 via respective client computing devices 10A and 10B (collectively, “client computing devices 10”) and network 9.

Web servers 12 provide an interface by which both organization 6A and donor 8A may communicate with donation management system 4 via network 9. In one configuration, web servers 12 execute web server software, such as Internet Information Server™ from Microsoft Corporation, of Redmond, Wash. As such, web servers 12 provide an environment for interacting with organization 6A and donor 8A according to user interface modules 14A, which can include Active Server Pages, web pages written in hypertext markup language (HTML) or dynamic HTML, Active X modules, Lotus scripts, Java scripts, Java Applets, Distributed Component Object Modules (DCOM) and the like.

Although illustrated as “server side” user interface modules executing within an operating environment provided by web server 12, user interface modules 14A could readily be implemented as “client-side” user interface modules 14B executing on client computing devices 10 used by organization 6A and donor 8A. User interface module 14A could, for example, be implemented as Active X modules executed by web browsers 16 executing on client computing devices 10, as shown in FIG. 2.

User interface modules 14A may include a number of modules including organization manager 18, donor manager 20, group manager 22, donation manager 24, and template manager 26. User interface modules 14A interact with database server 28 to access data 30, which may include organization data 30A, donor data 30B, group data 30C, donation data 30D, templates 30E, and configuration data 30F. Data 30 may be stored in a variety of forms including data storage files, or one or more database management systems (DBMS) executing on one or more database servers. The database management systems may be a relational (RDBMS), hierarchical (HDBMS), multidimensional (MDBMS), object oriented (ODBMS or OODBMS) or object relational (ORDBMS) database management system. Data 30 could, for example, be stored within a single relational database such as SQL Server from Microsoft Corporation.

Organization data 30A includes text, graphics, or other data uploaded by organization 6A to describe programs for soliciting donations. Exemplary text may include a description of the organization and programs within the organization that are accepting donations. Graphics may include organization graphics, such as trademarks, logos, and other imagery, and may be stored as, for example, individual image files stored in any of a number of formats including JPEG, TIFF, GIFF, PDF, and the like.

Donor data 30B and group data 30C also may include similar text, graphics and other data as organization data 30A. Generally, donor 8A uploads donor data 30B and the founding member of a group uploads group data 30C. Donor data 30B include data for each individual donor, such as a donor name, contact information, e.g., an email address, home address and phone number, billing information, amount donated by the individual, renewal data, and the like. Group data 30C includes data that defines the overall donation group, and may include a group name, a founding member name, a group description, a beneficiary program, a number of members, a total amount donated, group contact information, and the like.

Donation data 30D describes individual transactions, i.e., donations, and may include a donor name, a donation amount, a date and time of donation, a beneficiary program, a group name, donor billing information, e.g., credit card information and a billing address, a shared sponsor associate name, and the like. Templates 30E stores templates for creating updates, newsletters, electronic mail messages (referred to herein as, “emails”), and electronic invitations, and typically describe a layout, format, and a number of fields. Configuration data 30F stores configuration data including organizations 6 and donors 8 preferences, such as a preferred update or newsletter template.

Organization manager 18 is a software module that provides a user interface that allows organization 6A to configure organization data 30A. In particular, organization 6A may interact with organization manager 18 to add, edit or delete organization data 30A to manage one or more charitable programs. For example, organization 6A may comprise a university, and the university may interact with donation management system 6A to add a mathematics program to organization data 30A, thereby creating an online presence for the solicitations of donations for a mathematics department of the university. In some embodiments, organization manager 18 also provides one or more user interfaces to allow organizations, such as organization 6A, to further configure organization data 30A. In these embodiments, organization 6A may interact with these one or more user interfaces to specify sub-programs of each of the charitable programs. For example, organization 6A may interact with organization manager 18 to establish specific sub-programs of the mathematics program, such as specific mathematic scholarships, mathematic fellowships, and mathematic research. Organization manager 18 may associate each of these sub-programs to corresponding programs within organization data 30A.

Once organizations 6 create charitable programs by interacting with donation management system 4, donors 8 may begin creating groups by interacting with group manager 22. Group manager 22 is a software module that provides a user interface module that allows donors 8 to add, edit, or delete donation groups stored within group data 30C. Donor 8A may, for example, interact with group manager 22 to create a public or private group that specifies the mathematic program, mentioned above, as the beneficiary of the group's donations. In creating a group, the founding member, such as donor 8A in the above example, may also interact with donor manager 20. Donor manager 20 is a software module that provides a user interface module that allows donors 8 to add, edit, or delete their specific donor information stored in donor data 30B.

After the group is created, the group's founding member may send invitations to donors 8 asking these invited donors to join the newly created group. In some instances, private groups require that the invited donors accept the invitation to join the group, while public groups may not require the invited donor to accept the invitation to join. The one or more of donors 8 may join the group by interacting with user interface modules provided by group manager 22 and donor manager 20. For example, a donor 8 may input his or her specific donor information into the user interface provided by donor manager 20, and may interact with group manager 22 to register with one or more groups.

After the one or more of donors 8 become members of a defined group, the donors may interact with a user interface module provided by donation manager 24 to make individual donations or setup recurring automated donations. The one or more of donors 8 may enter, for example, a date of a donation, billing information, and other above necessary donation information. Donation manager 24 receives the donation information and updates donation data 30D to reflect the new donation information. At any time after making a donation, the one or more of donors 8 may interact with the user interface module provided by donation manager 24 to view donation data 30D corresponding to each of the one or more of donors 8. Donation management system 4 may keep some of donation data 30D, such as credit card numbers, secure and may not allow other of donors 8 to view such information.

In some groups, group members may view at least a portion of donation information corresponding to other group members. For example, a group member may view donation totals and invited donation totals for other members of the group to inspire competition or foster group morale. Organizations 6 may also view donation data corresponding to each of organizations 6 via interactions with the user interface module provided by donation manager 24. In some embodiments, a group may choose what data is maintained privately and what data is made public, such as whether to show names, initials, or no individual details. In other embodiments, only group members may see the names and invited donation totals for each other group member. Donation management system 4 may further from “groups of groups” and allow member groups to view data corresponding to other member groups. For example, a plurality of Girl Scout groups may be grouped into a single encompassing Girl Scout group and the plurality of Girl Scout groups may be able to view members' donations of all of the plurality of Girl Scout groups. Each of donors 8 may further have the option to make donations anonymously.

A beneficiary organization of a group may also inform donors 8 that are members of the group about the status and recent happenings of the beneficiary organization. If the group is a public group, the beneficiary organization may communicate by emails, electronic invitations and/or newsletters with donors 8 to inform donors 8 of the new group. The beneficiary organization may interact with a user interface provided by template manager 26 to select one of templates 30E. The beneficiary organization may upload graphics, specify text, and alter the format of a selected one of templates 30E to suit the needs of the group via interactions with template manager 26. Once the selected template is configured, the beneficiary organization may send the newsletter, email, and/or electronic invitation to one or more of donors 8. Similar to the public group, a beneficiary organization of a private group interacts with template manager 26 to select one of templates 30E that corresponds to one or more of communications, such as emails, electronic invitations and/or newsletters. The beneficiary organization may create and send the communications to one or more of donors 8 informing the one or more of donors 8 that a new group has been created and the one or more donors 8 are welcome to join the new group.

Organizations 6 and donors 8 may establish preferences via interactions with user interface modules provided by organization manager 18, donor manager 20, group manager 22, donation manager 24 and template manager 26. The preferences are stored in configuration data 30F such that when organization 6A and donor 8A, for example, re-access donation management system 4, donation management system 4 may reload the preferences stored in configuration data 30F.

Throughout the process of configuring programs, groups, donors, and donations, donation management system 4 may provide secure connections through network 9 to each of client computing devices 10. Donation management system 4 may encrypt communications to ensure the privacy of data sent across network 9. Thus, donation management system 4 may securely provide donation information to organizations 6 and donors 8. While not shown in FIG. 2, donation management system 4 may, in some embodiments, include a computer-readable medium, such as a magnetic hard-drive, Random Access Medium (RAM), Electronic Programmable Read Only Medium (EPROM), and Field Programmable Gate Array (FPGA). The computer-readable medium may store instructions to cause a programmable processor to perform the techniques of the invention as described herein.

In this manner, organizations, such as organization 6A, may specify various programs within the organization for soliciting donations and donors, such as donor 8A, may create a group that specifies one of the programs as a beneficiary of the group's donations. The donors may create a public or a private group and may structure the group to around a continuous model, i.e., the structure of the group is not limited to events. For example, the group may specify a child as the beneficiary of the group's donations and the group may continue making donations until the child passes a set age. These and other features of donation management system 4 are described in more detail below.

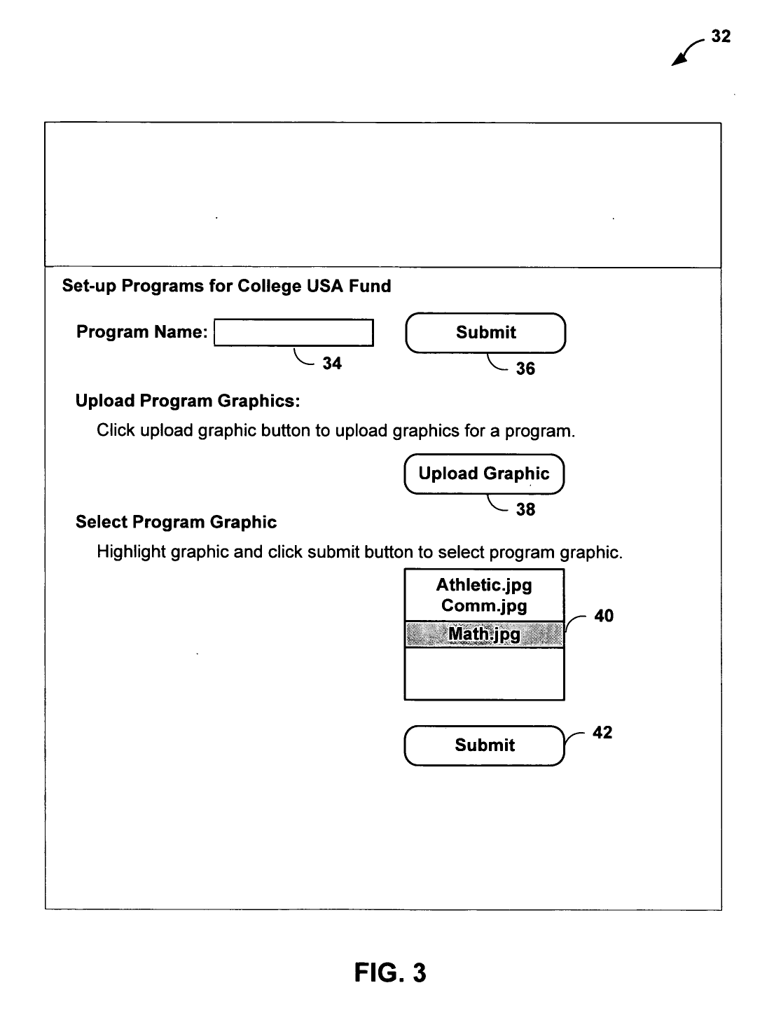

FIG. 3 is an example web-based user interface 32 presented by organization manager 18 with which a charitable organization 6 interacts to set-up a program. As shown in FIG. 3, user interface 32 includes a text input 34, a submit input 36, an update graphic input 38, a selection box input 40 and another submit input 42. An organization, such as organization 6A, may configure programs for soliciting donations by interacting with inputs 34-42.

Organization 6A may specify a name for a program by typing the program name into text input 34 and subsequently selecting submit input 36. In response to submit input 36, organization manager 18 creates a new program within organization data 30A with a name as specified in text input 34. After specifying the name, organization 6A may upload a graphic by selecting upload graphic input 38. Organization manager 18 receives the graphic and stores the graphic to organization data 30A and also updates select box input 40 to include the recently uploaded graphic. To finish configuring the program, organization 6A may highlight a graphic name, such as “Math.jpg” shown in FIG. 3, from select box input 40 and selects submit input 42. Organization manager 18, in response to selection of submit input 42, links the selected graphic with the specified program name within organization data 30A. Via organization manager 18, organizations may configure one or more programs within the organizations for soliciting donations within donation management system 4.

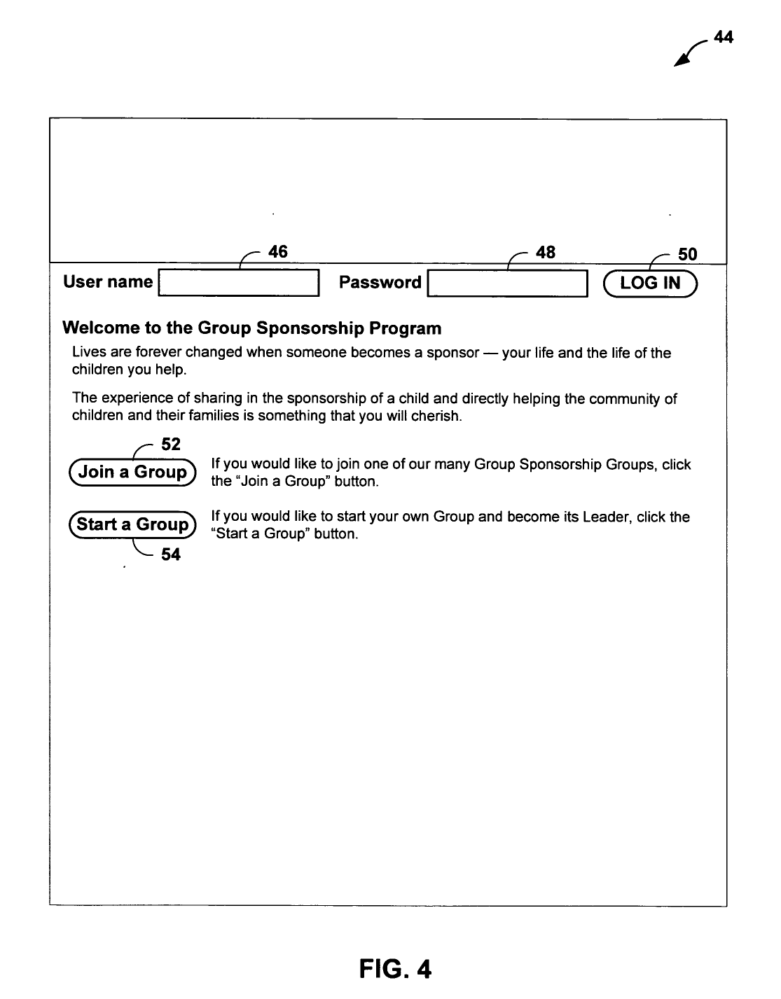

FIG. 4 is an example web-based user interface 44 presented by group manager 22 to receive a selection to either join a donation group or create a new donation group. User interface 44 includes various inputs, such as user name input 46, password input 48 and log in input 50, group join input 52 and group start input 54, for logging into database management system 4, joining a group and starting a new group. User name input 46, password input 48, and log in input 50 allow a donor, such as donor 8A, to log into database management system 4. By logging in, database management system 4 may configure subsequently presented user interfaces in accordance with user preferences stored as configuration data 30F. A donor may only log in after registering with database management system 4, starting a group, or joining a group, which all require the donor to enter donor information via user interface modules provided by donor manager 20, as described in detail below.

A donor, such as donor 8A, may join a group by selecting group join input 52 and may start a group by selecting group start input 54. In response to selecting group join input 52, group manager 22 presents a new user interface. Similarly, in response to selecting group start input 54, group manager 22 presents another new user interface. Both of these new user interfaces are described in more detail below.

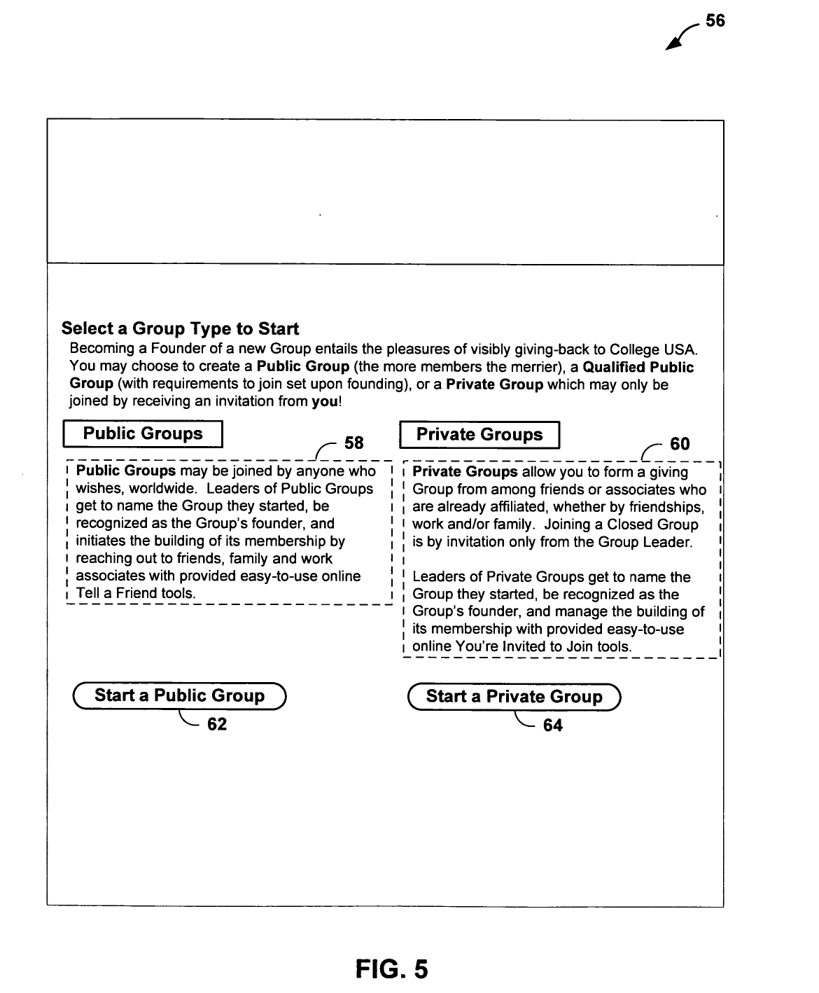

FIG. 5 is an example web-based user interface 56 presented by group manager 22 in response to selecting group start input 54 of FIG. 4. User interface 56 includes a public group text box 58 and a private group text box 60 that describe public and private groups, respectively. User interface 56 also includes public group start input 62 and private group start input 64. If a donor, such as donor 8A, selects public group start input 62, group manager 22 creates a new public group within group data 30C. However, if donor 8A, for example, selects private group start input 64, group manager 22 creates a new private group within group data 30C.

Regardless of the selection, group manager 22 may provide a group registration user interface that presents inputs to gather group information about the new group and update group data 30C based on the group information. Donor manager 20 may present portions of the group registration user interface or may present a subsequent donor registration user interface that presents inputs to gather donor information from the founding member. Donor manager 20 may then update donor data 30B based on the donor information entered by the founding member. In some embodiments, group manager 22 may update both group data 30C and donor data 30B with the entered group information and donor information and donor manager 20 may not be necessary to update donor data 30B.

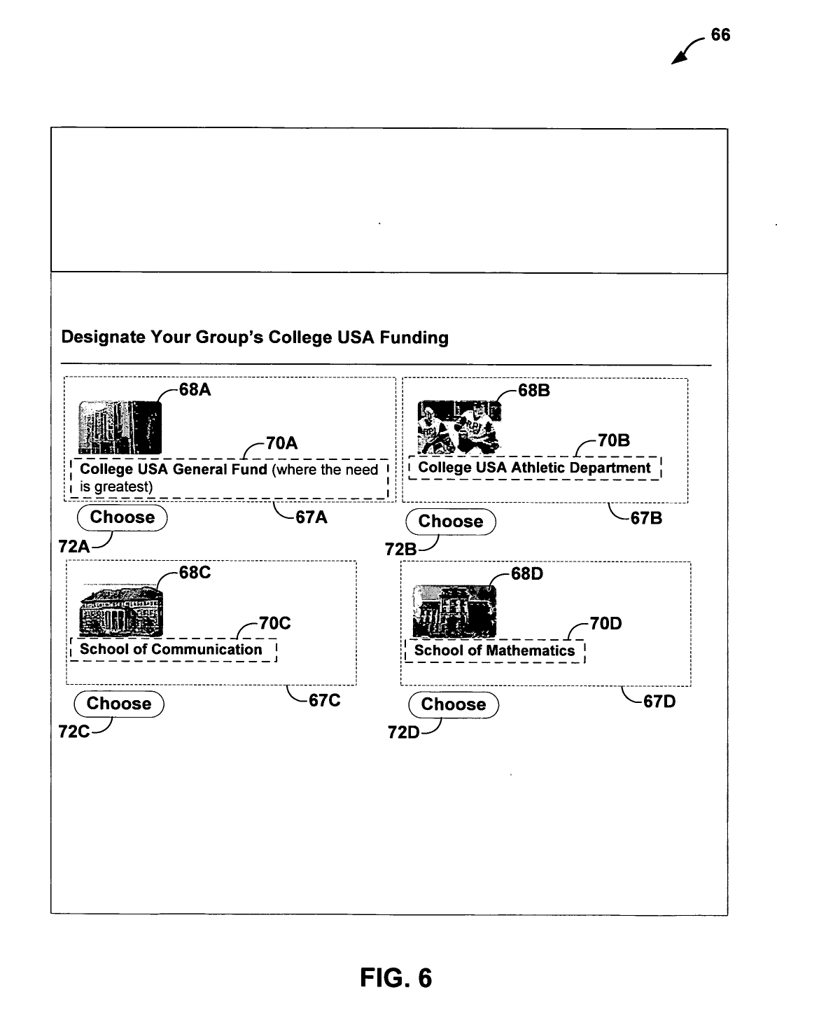

FIG. 6 is an example web-based user interface 66 presented by group manager 22 to receive a program selection for the group being created. In this example, user interface 66 includes programs 67A-67D and each of programs 67A-67D includes a respective one of graphics 68A-68D and respective one of name text boxes 70A-70D. User interface 66 also includes choose inputs 72A-72D for each of programs 67A-67D.

Graphics 68A-68D are exemplary graphics that an organization titled “College USA Funding” (as shown in FIG. 6) uploaded via interaction with user interface 32 (FIG. 3) when specifying programs 67A-67D. The organization titled “College USA Funding” also specified a name for each of programs 67A-67D via interactions with user interface 32 and name text boxes 70A-70D are exemplary names specified using user interface 32. Group manager 22 may access organization data 30A based on organization selection specified in a group registration user interface. As such, one of donors 8, such as donor 8A, may select any one of choose inputs 72A-72D to choose an associated one of programs 67A-67D. Group manager 22, in response to a selection of one of choose inputs 72A-72D, associates the chosen one of programs 67A-67D with the new group and stores the association within group data 30C. After receiving the selection of one of programs 67A-67D, group manager 22 may provide another user interface that presents an overview of the new group, as described in detail below.

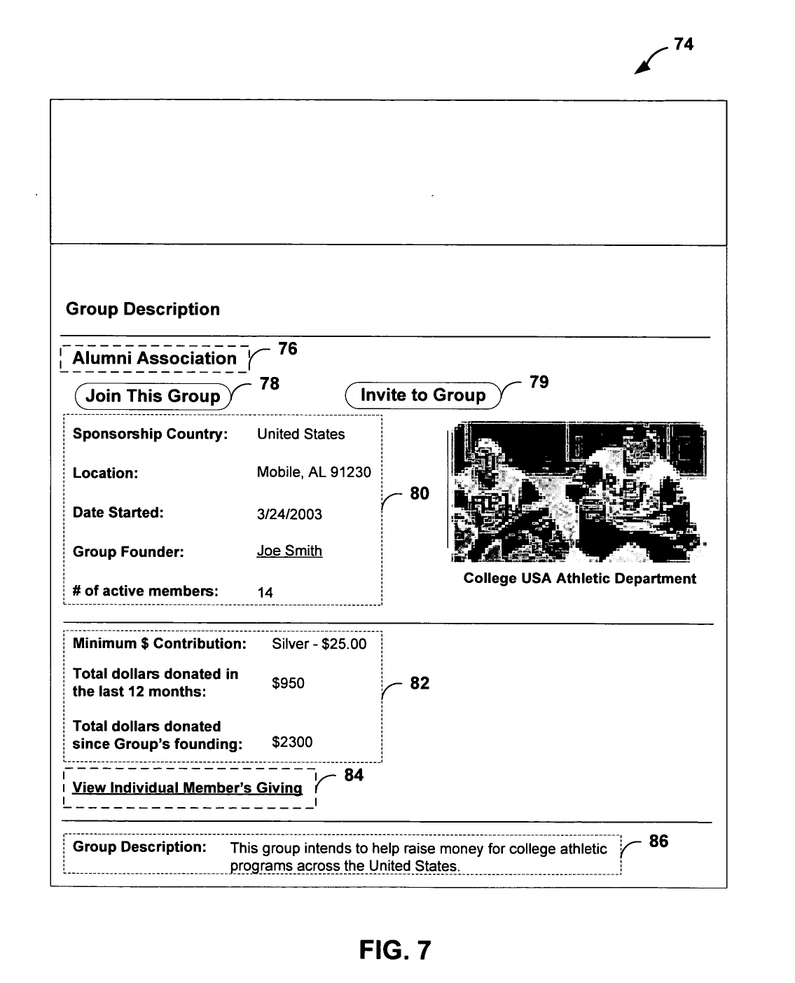

FIG. 7 is an example web-based user interface 74 presented by group manager 22 to display information about a newly created donation group. Group manager 22 may present user interface 74 after one of donors 8 selects one of choose inputs 72A-72D (FIG. 6) to show an overview of the newly created group. Group manager 22 may also present user interface 74 in the event one of donors 8 selects to join the “Alumni Association” group using group join input 52 (FIG. 4). User interface 74 presents an overview of a group and includes group name text 76, group join input 78, invite input 79, group information text 80, group donation information text 82, member list link 84, and group description text 86.

As shown in FIG. 7, user interface 74 presents an overview of the “Alumni Association” group. The “Alumni Association” group is a public group since non-members may select group join input 78 to join the group. User interface 74 presents group invite input 79 that allows members to invite non-members. Both public and private groups may invite members, but public groups do not require members to accept an invitation to join the group.

Group information text 80 includes a sponsorship country, a location, a date the group started, group founder, and the number of active members. Group manager 22 accesses group data 30C and presents the accessed data corresponding to the group as group information text 80. Group manager 22 may present some data in the form of web links, i.e., the group founder Joe Smith, and donors 8 may select on the “Joe Smith” link to view more information regarding Joe Smith. Typically, donor manager 20 presents the additional information regarding Joe Smith on a subsequent user interface.

Group manager 22 may also access donation data 30D to present group donation information text 82. Group donation information text 82 includes a minimum contribution amount, a total dollars donated in the last 12 months, a total dollars donated since Group's founding, and the like. The group founder or founding member may specify the minimum contribution amount during group registrations. Minimum contribution amounts may be described as silver, gold and platinum levels, where the platinum level is the highest minimum. The group founder may also specify group information text 86 during group registration.

Group manager 22 may also present member list link 84 within user interface 74 to allow donors 8 to view a list of group members. The member list may include a number of donations, a total donation amount per member, and other such member information to increase competition among members. In particular, viewing other members total donations may allow for school competitions, community competitions, and the like and may increase donations for all competitive groups.

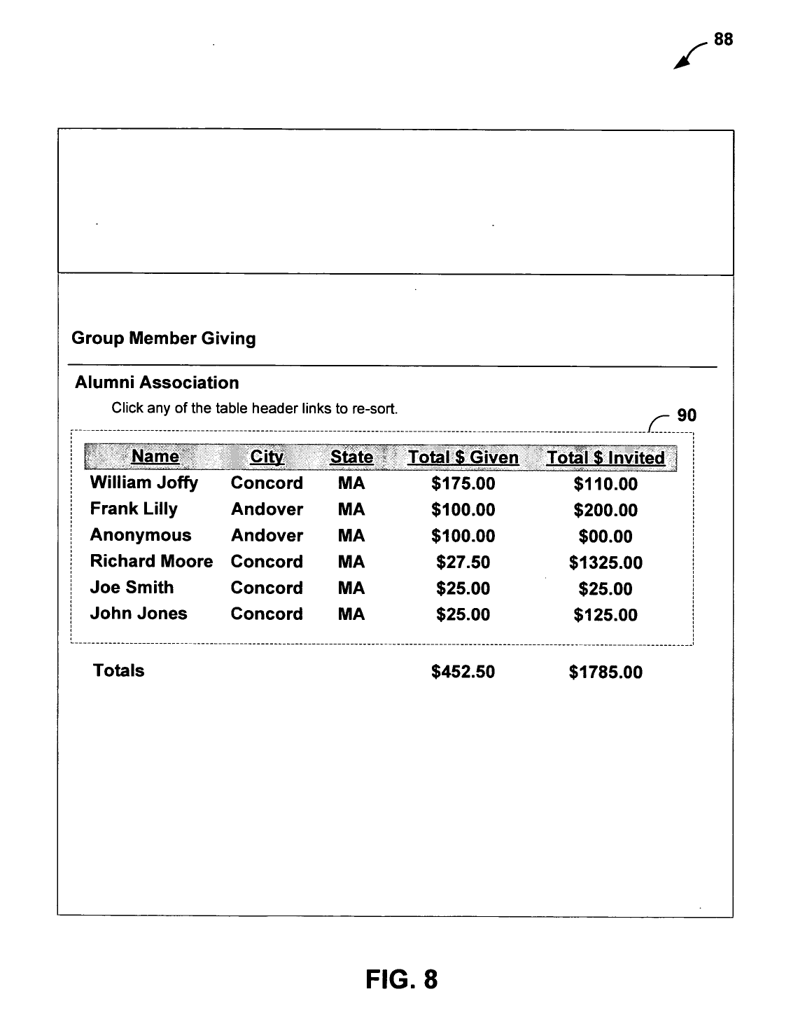

FIG. 8 is an example web-based user interface 88 presented by group manager 22 to display donor contributions and invite data. User interface 88 includes table 90 that lists a donor name, a donor city, a donor state, a total amount given per donor, and a total amount invited per donor, i.e., invite data, in each row. Donor manager 20 maintains donation data 30D to include the invite data that specifies for each donor a total dollar amount donated by others in response to an electronic invitation sent by that donor. Group manager 22 may access both donation data 30D and donor data 30C to populate the rows of table 90. Providing a real-time listing of total contributions may eliminate a need for organizations 6 to print costly year-end contribution books to recognize donors 8.

Table 90 may be resorted by selecting one of the column headers. For example, selecting the “Total $ Given” header of the fourth column of table 90 resorts the table by the “Total $ Given.” Therefore, donors 8 may sort table 90 according to any criteria specified in table 90 and may accurately determine a member of the group that has donated the most amount of money. Table 90 may also be sorted based on the “Total $ Invited.” A total amount invited specifies a total amount donated by other donors resulting from invitations sent to other donors by the member donor. For example, donor William Joffy has a “Total $ Invited” of $110.00, which suggests that William Joffy has invited non-members to join a group and at least some of these non-members have joined the group and donated a total of $110.00. The non-members do not have to join the same group as William Joffy as long as the group is within donation management system 4 or other similar systems that communicate with donation management system 4. In some embodiments, only portions of the invited donations are attributed to William Joffy and the portion may be decided based on which group the non-member joined, the amount the non-member donates, and other such criteria.

In this manner, donors 8 may view table 90 to determine a member of a group that has the largest donation total and/or the largest Total $ Invited total. In a competitively-conscious group, where, for example, a prize is awarded to the donor with the largest donation total, the member donors may quickly determine the donor that is in the lead, i.e., the donor with the largest donation total (or similarly for the largest Total $ Invited total.) Table 90 may foster the competition between members, which in turn may encourage increased donating by the members. Further, the total amount invited may factor into the competition and may provide a unique or added variable when determining the winning donor.

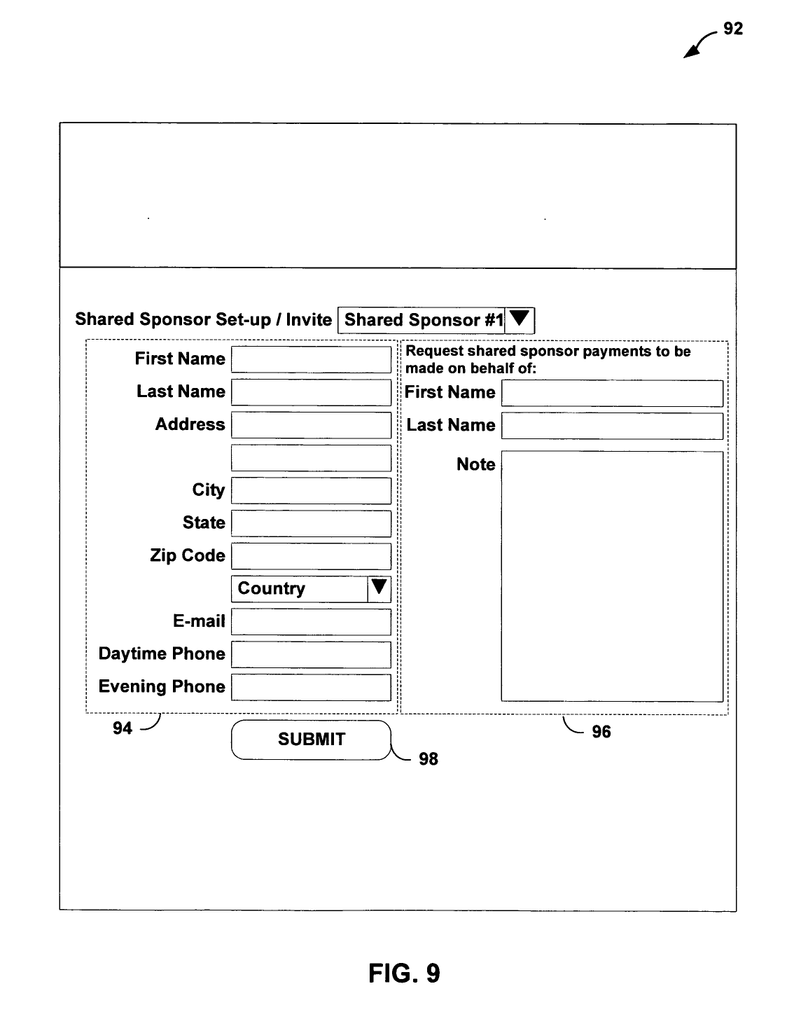

FIG. 9 is an example web-based user interface 92 presented by template manager 26 in response to selecting invite input 79 of FIG. 7. Through interaction with user interface 92, donors 8 may configure an electronic invitation template stored to templates 30E. In particular, one of donors 8 may specify another of donors 8 to invite by interacting with donor invite text inputs 94, associate donor invite text inputs 96 and submit input 98 included within user interface 92.

Donor 8A, for example, may invite another potential donor by specifying his or her contact information within donor invite text inputs 94. Donor invite text inputs 94 may include a first name input, a last name input, an address input, a city input, a state input, a zip code input, a country input, an e-mail input, a daytime phone input, an evening phone input, and other such donor information inputs of another of donors 8. Using invite text inputs 96, donor 8A may specify another individual and an associated email address on the behalf of which the invited potential donor may make payments. Invite text inputs 96 provide a means for entering “associate donor information,” and may include a first name input, a last name input, an email address and a note input. Upon entering donor information for the invitee and optional associate donor information, donor 8 selects submit input 98.

In response to selection of submit input 98, template manager 26 populates an electronic invitation template stored within template data 30E with any entered donor information and any optional associate donor information. Template manager 26 may then send the electronic invitation to the invitee, the specified associate donor, or both. The electronic invitation sent to the invitee and the associate donor may be a similar invitation or may be a different invitation depending on their membership status. In this manner, donors 8 may be invited to join groups and make donations on behalf of another individual. Thus, donation management system 4 provides for comprehensive donation management that is not limited to direct donations and may further allow private groups and in some embodiments, public groups, to invite non-members to join.

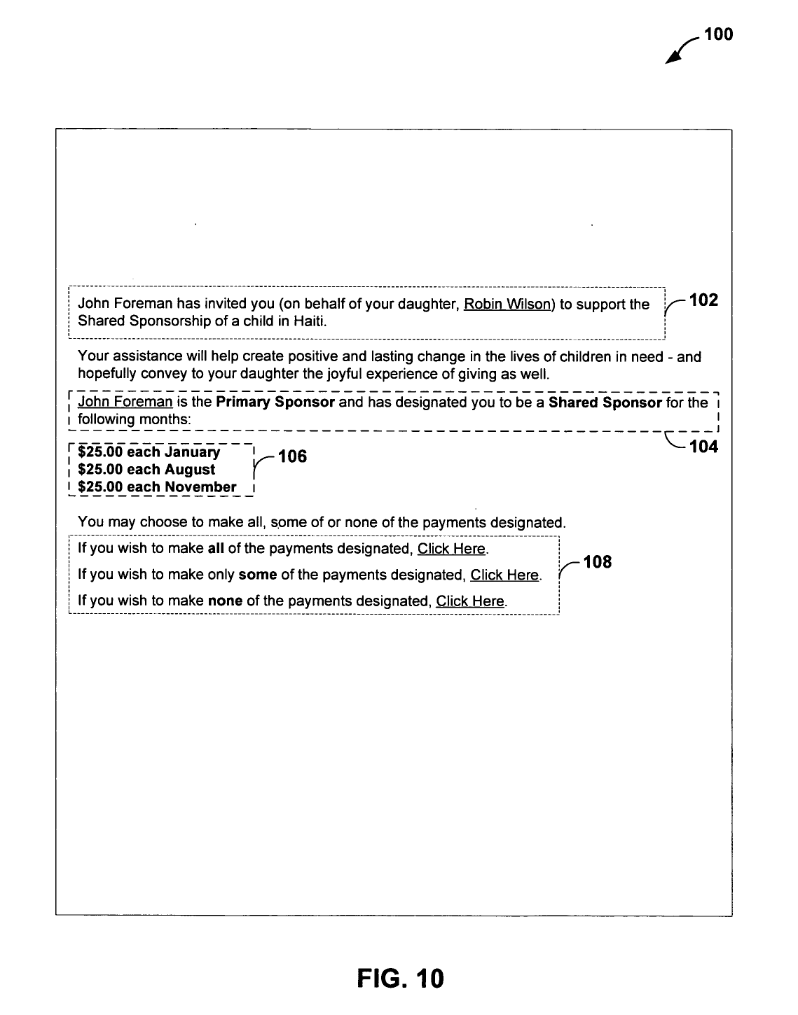

FIG. 10 is an example electronic invitation 100 sent by donation management system 4 to request a donation on behalf of one of donors 8. In particular, template manager 26 may send electronic invitation 100 to a client computing device, such as client computing device 10B, via network 9. The recipient invitee may interact with electronic invitation 100 to join a group. In this example, electronic invitation 100 includes text boxes 102-106 that invite the invitee to make donations of $25.00 in January, August, and November on behalf of individual, i.e., “Robin Wilson,” and action links 108 that allow the invitee to accept all, some or none of the suggested donation amount and dates.

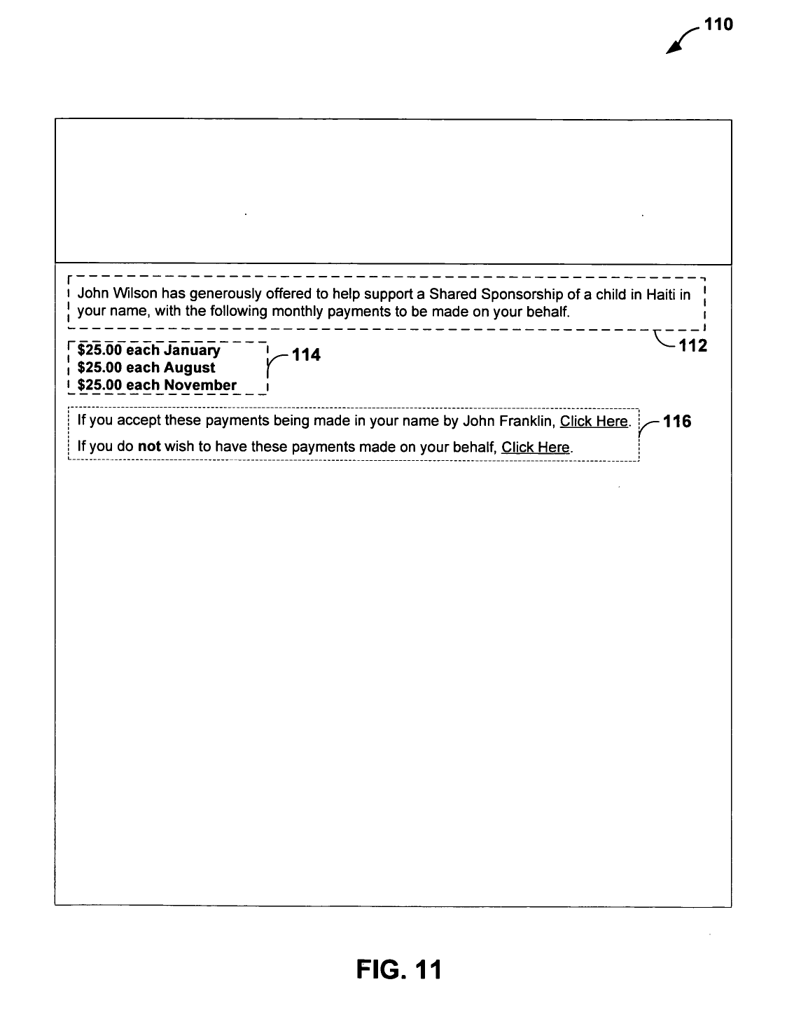

FIG. 11 is another example electronic invitation 110 sent by donation management system 4 in response to an invitee agreeing to make payments on behalf of another individual. Again, template manager 26 may send electronic invitation 110 to one of donors 8 via network 9 and a client computing device, such as client computing device 10B. Electronic invitation 110 differs from electronic invitation 100 since electronic invitation 110 informs the recipient, i.e., an associate donor, that another individual, i.e., the paying donor, has agreed to make donations on his or her behalf. In particular, electronic invitation 110 includes text boxes 112 and 114 to inform the associate donor of the paying donor's name, amount of each donation, and the date of each donation. Electronic invitation 110 also includes action links 116 that allow the associate donor to permit the paying donor to make the donations or not make the donations in the associate donor's name.

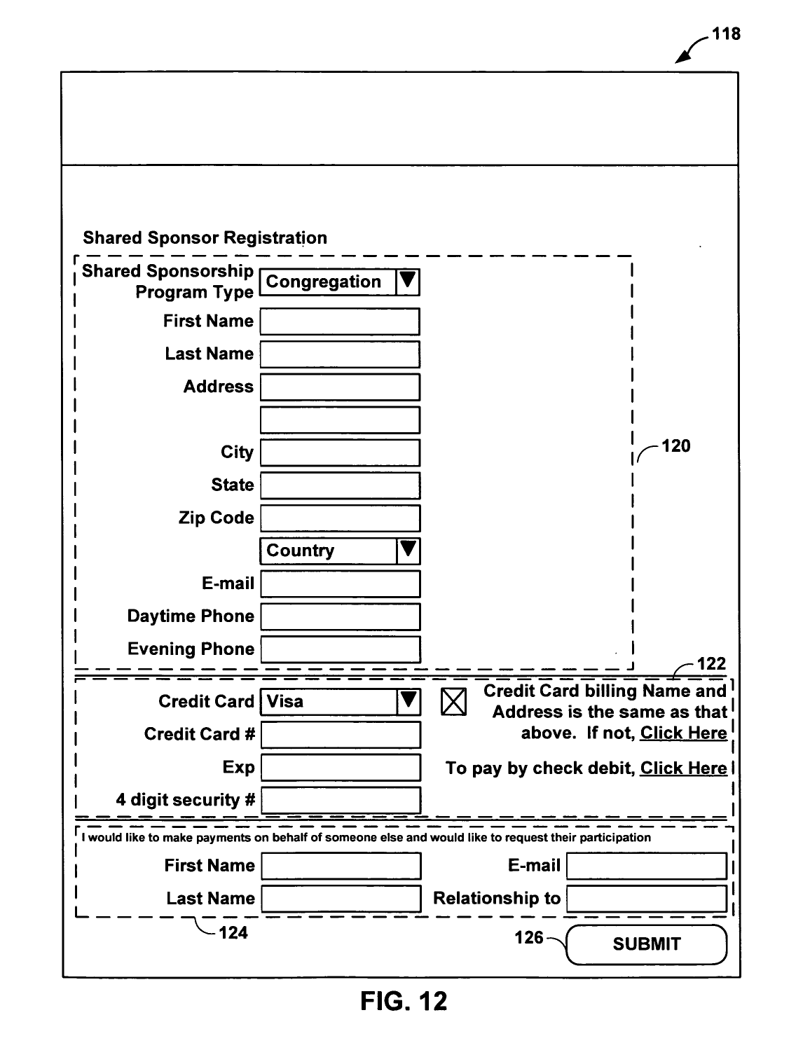

FIG. 12 is a web-based user interface 118 presented by donor manager 20 once the associate donor agrees to the donations made on his or her behalf. In particular, donor manager 20 may present user interface 118 to the paying donor in response to an associate donor accepting the donations. The paying donor may access donor management system 118 to register to make the donations on the associate donor's behalf via interactions with user interface 118. User interface 118 includes donor information text inputs 120, donor billing information text inputs 122, and associate donor information text inputs 124, as well as submit input 126 to initiate registration of the paying donor.

The paying donor enters donor information, billing information and associate information, each as described above, into respective donor information text inputs 120, donor billing information text inputs 122 and associate donor information text inputs 124 and selects submit input 126. Donor manager 20 receives the donor information, donor billing information, and associate donor information and updates donor data 30C and donation data 30D based on the received information.

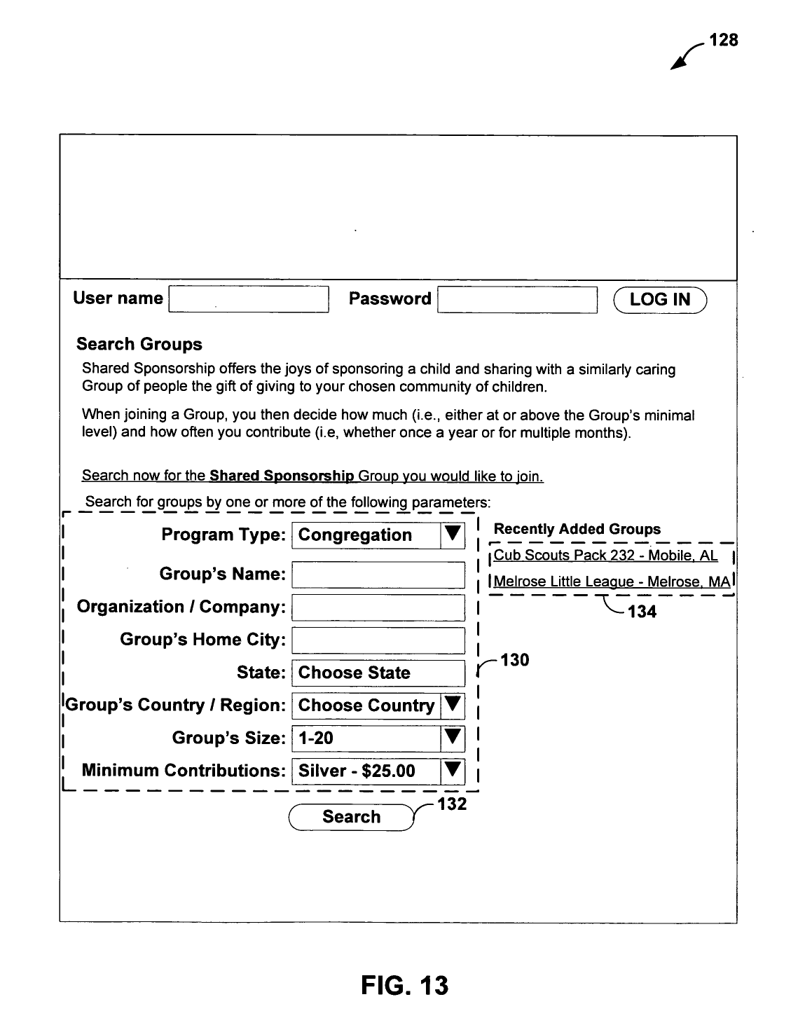

FIG. 13 is a web-based user interface 128 presented by group manager 22 to enable donors 8 to search for a public group. User interface 128 includes search criteria inputs 130 and a submit input 132 to facilitate donors 8 in searching for public groups to join. Search criteria inputs 130 includes inputs to specify search criteria such as a program type, a group's name, an organization/company, group's home city, a group's state, a group's country/region, a group's size, e.g., number of members, and a group minimum contribution limit. Donors 8 may specify search criteria using search criteria inputs 130 and select search input 132. In response to selecting search input 132, group manager 22 accesses group data 30C and presents groups that satisfy the search criteria specified by donors 8. User interface 128 also includes recent group links 134 that allow donors 8 to access information describing groups recently added to donation management system 4.

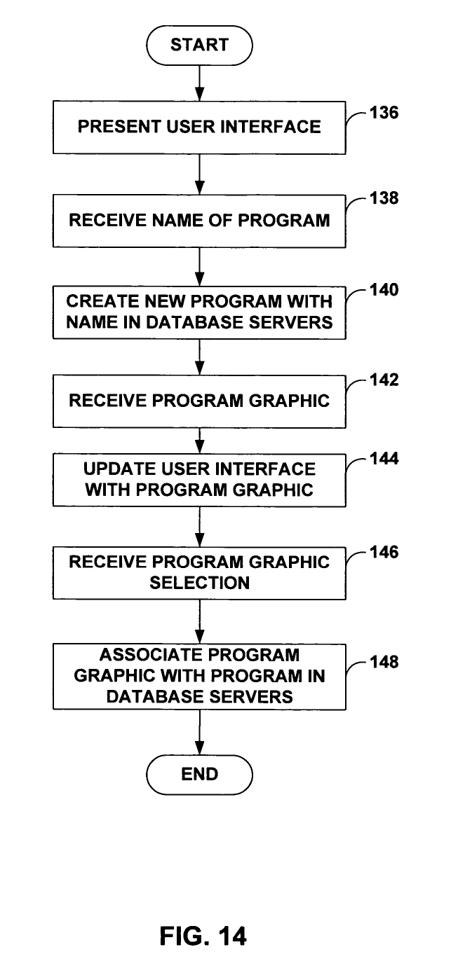

FIG. 14 is a flowchart illustrating exemplary operation of donation management system 4 when an organization creates an online charitable program for soliciting donations. Initially, an organization, such as organization 6A (FIG. 2), may access a donation management system 4 via network 9 and a client computing device 10A. In response, donation management system 4 present a user interface, such as user interface 32 of FIG. 3 (136). In particular, user interface modules 14A of donation management system 4, and more particularly, organization manager 18 presents user interface 32 to the organization.

Next, organization manager 18 receives a name for a new program (138) via text input 34 of FIG. 3 in response to organization 6A selecting submit input 36. Organization manager 18 creates a new program within organization data 30A (140) and may further receive a program graphic once organization 6A selects upload graphic input 38 (142). Organization manager 18 updates selection box input 40 with the name of the recently uploaded graphic (144).

Organization 6A may select a name of a program graphic displayed within selection box input 40 and submit input 42. Organization manager 18 receives the selection (146) and associates the selected program graphic with the new program created in organization data 30A (148). In this manner, donation management system 4 may be viewed as an online application service provider by which multiple organizations can define customized programs to solicit donations.

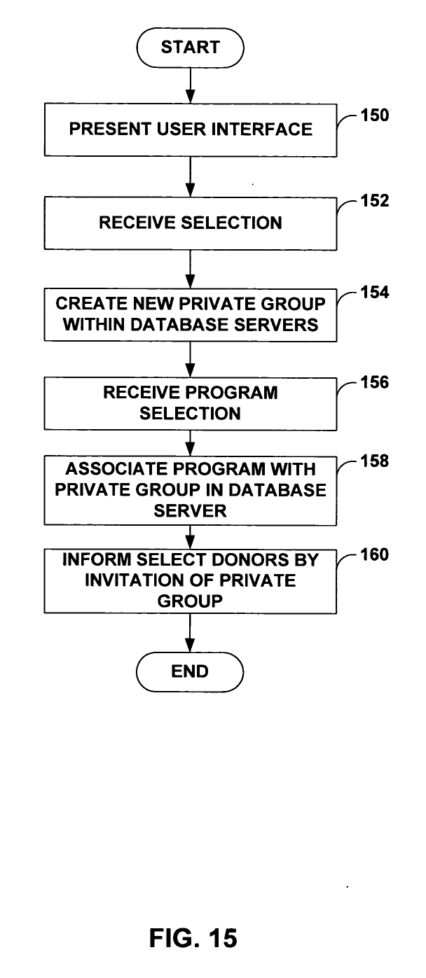

FIG. 15 is a flowchart illustrating exemplary operation of donation management system 4 in providing a user interface to create a private group. Initially, donation management system 4 (FIG. 2) presents a user interface (150), such as user interface 44 of FIG. 4, that allows one of donors 8 to create a group. One of donors 8, such as donor 8A, selects a group start input 54 and group manager 22 presents user interface 56 (FIG. 5) in response to the selection (152). Next, donor 8A selects private group start input 64, and group manager 22 creates a new private group within group data 30C (154) as well as presents a subsequent user interface, such as user interface 66.

Donor 8A interacts with user interface 66 to select one of programs 67A-67D as the beneficiary of the private group's donations by selecting one of choose inputs 72A-72D, and group manager receives the program selection (156). Group manager 22 associates the selected program with the newly created group within group data 30C (158), as described above, and presents a user interface to register the group within donation management system 4. The founding member of the group, i.e., donor 8A, may inform the public of the new group by inviting select donors 8 to join the group via an electronic invitation, such as electronic invitation 100 (160). Template manager 26 sends electronic invitation 100 in response to selection of submit input 98 (FIG. 9) by one of donors 8. In some embodiments, donation management system 4 may provide for associate donors and paying donors, as described above, and both of electronic invitations 100 and 110 may be sent to the associate donor and paying donor to inform them of the new group.

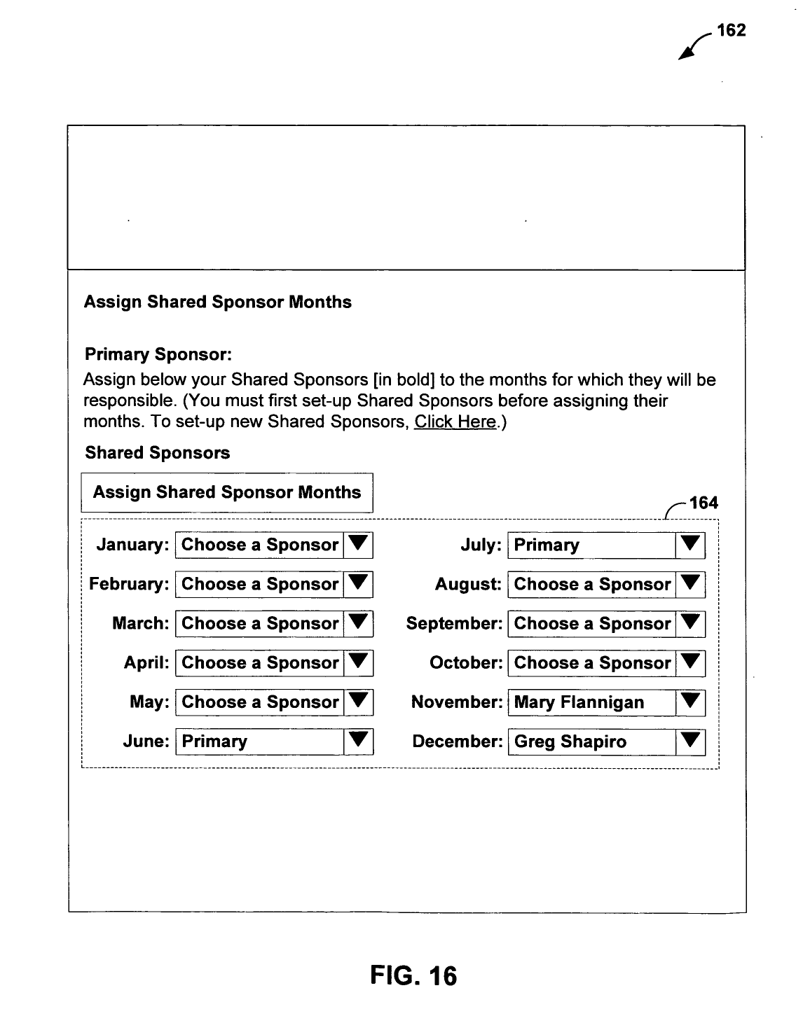

FIG. 16 is an exemplary web-based user interface 162 presented by group manager 22 to organize monthly contributions within a donation group. User interface 162 allows the founding member of the group to associate member donors with specific months of the year. In particular, user interface 162 includes pull-down boxes 164 that enable the founding member to select a member donor for each month of the year. Each of pull-down boxes 164 is aligned next to a month and the founding member, for example, may specify Mary Flannigan as the donor for the month of November, as shown in FIG. 16.

In this manner, donation management system 4 allows for groups to be organized around certain donor arrangements. For example, donations to a sponsored child typically occur on a monthly basis and the donations may be divided among member donors to reduce the cost a single donor would pay to support the sponsorship of a child. Thus, donation management system 4 may provide mechanisms, such as user interface 162 to share the costs of monthly donations within a group. While described in the context of monthly donations, the invention should not be limited to a monthly time frame and may include other time frames, such as daily, weekly or yearly.

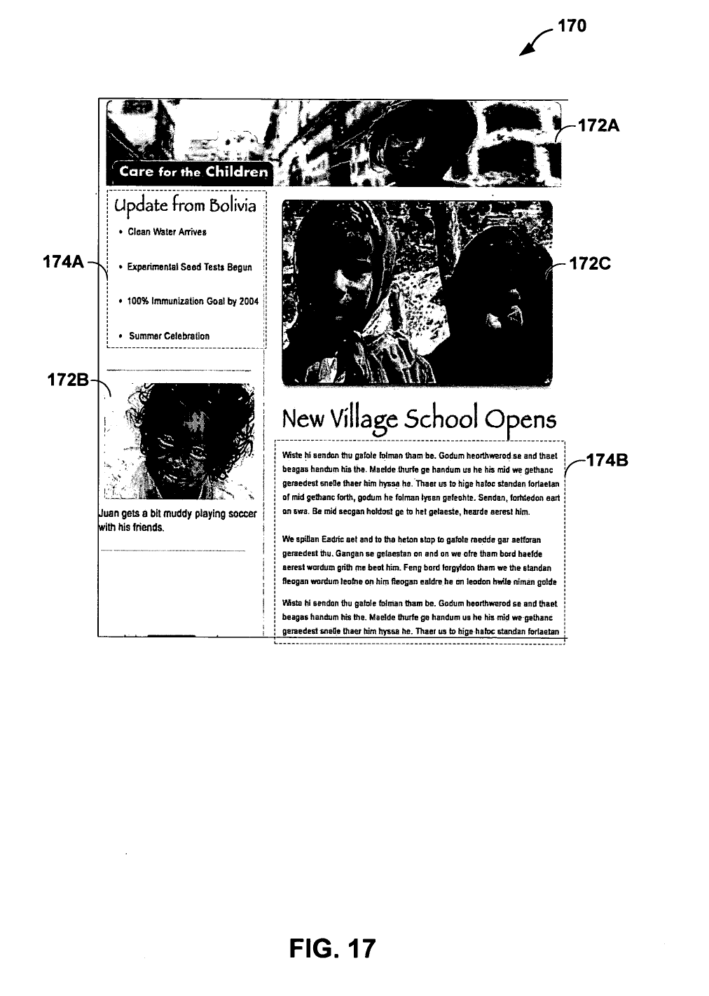

FIG. 17 is an exemplary newsletter 170 that a donor may receive from donation management system 4. A founding member of a group may interact with user interfaces (not shown) presented by template manager 26 to upload graphics, such as graphics 172A-172C included within newsletter 170. Moreover, the founding member may specify text, such as text 174A and 174B included with newsletter 170, via interactions with the user interface presented by template manager 26. Thus, newsletter 170 serves as an exemplary newsletter to inform the member donors of a group of the most recent activity concerning how the funds donated by the group are being used. Such updates will be available for each and every different designated program for which donation choices are offered at the time of forming each group. Various embodiments of the invention have been described. These and other embodiments are within the scope of the following claims.

1. A method for providing network-based management of donations comprising:
presenting a user interface to receive input to create a private donation group having one or more donors; and
receiving via a computer network electronic donations from the donors to the private donation group.

2. The method of claim 1, wherein the input specifies a charitable organization, the method further comprising distributing funds associated with the electronic donations to the charitable organizations.

3. The method of claim 1, wherein the user interface is a first user interface and the method further comprises:
presenting a second user interface by which one or more of the donors configure an electronic invitation having an associated invited donor; and
requiring that the invited donor associated with the electronic invitation accept the electronic invitation in order to become a member of the private donation group.

4. The method of claim 3, wherein the user interface is a first user interface and the method further comprises:
issuing the electronic invitation from a member donor of the private donation group to the donor; and
presenting a second user interface to receive a selection from the invited donor to join the private donation group.

5. The method of claim 1, further comprising:
receiving login information associated with a user;
determining whether the user is a member of the private donation group; and
presenting information associated with the private donation group to the user based on the determination when the user is a member of the private donation group.

6. The method of claim 5, wherein the information associated with the private donation group includes one or more of a total amount invited per each of the donors of the private donation group, a total amount donated per each of the donors, and a list of the doors.

7. The method of claim 1, wherein the user interface is a first user interface and the method further comprises:
presenting a second user interface to receive input to create a sub-group within the private group;
presenting a third user interface to receive input to create a public donation group; and
receiving electronic donations for the sub-group and the public donation group via the computer network.

8. The method of claim 1, wherein the private donation group comprises an honor group formed to honor one or more individuals, and the input specifies a charity to which donations are made in honor of the one or more individuals.

9. The method of claim 8, the method further comprising presenting a user interface to receive from the donors electronic content associated with the individual at least one of a photo, a caption, and an anecdote.

10. A method for providing network-based management of donations comprising:
presenting a user interface to specify a paying donor that makes electronic donations on behalf of an associate donor; and
receiving the electronic donations from the paying donor on behalf of the associate donor via a computer network.

11. The method of claim 10, further comprising distributing funds associated with the electronic donations to one or more charitable organizations.

12. The method of claim 10, wherein the user interface comprises one or more donor invite inputs to specify the paying donor.

13. The method of claim 12, further comprising communicating with the paying donor to receive permission from the paying donor to make the electronic donations on behalf of the associate donor in response to information entered into the one or more donor invite inputs.

14. The method of claim 13, wherein communicating with the paying donor comprises sending electronic mail to the paying donor.

15. The method of claim 10, wherein the user interface is a first user interface and the method further comprises presenting a user interface to specify the associate donor, wherein the second user interface comprises associate donor invite inputs to specify the associate donor.

16. The method of claim 15, further comprising communicating with the associate donor to receive permission from the associate donor to allow the paying donor to make the electronic donations on behalf of the associate donor in response to information entered into the one or more associate donor invite inputs.

17. The method of claim 16, wherein communicating with the associate donor comprises sending electronic mail to the associate donor.

18. The method of claim 15, wherein the first and second user interfaces are the same user interface.

19. The method of claim 10, further comprising requiring permission from both the paying donor and the associate donor prior to allowing the paying donor to make the electronic donations on behalf of the associate donor.

20. A method for providing network-based management of donations comprising:
maintaining a database defining a donation group that includes one or more donors, wherein the database stores invite data for each donor specifying a total dollar amount donated by one or more other donors in response to an electronic invitation by the donor; and
presenting a user interface to display the invite data for each of the donors of the donation group.

21. The method of claim 20, wherein the other donors includes members of the donation group and members of other donation groups.

22. The method of claim 20, further comprising sending the electronic invitation from one of the one or more donors to one or more other donors to invite the one or more other donors to join the donation group.

23. The method of claim 22, wherein the user interface is a first user interface and the method further comprises:
presenting a second user interface to receive a response from each of the one or more other donors that receive the electronic invitation; and
adding the one or more other donors to the donation group based on each response.

24. The method of claim 20, wherein the donation group includes a private donation group that requires the one or more other donors to accept the electronic invitation to join the group.

25. The method of claim 20, wherein the donation group includes a public donation group.

26. The method of claim 20, wherein the user interface further displays one or more of a total amount donated, a member donor name, a member donor city, a member donor state and a member donor country.

27. A method for providing network-based management of donations comprising:
maintaining a database defining a plurality of donors and a plurality of donation intervals over a time period;
presenting a user interface to associate at least one of the plurality of donors with each of the plurality of donation intervals; and
receiving electronic donations from each of the plurality of donors at the donation interval associated with the respective donor.

28. The method of claim 27,
wherein one of the plurality of donors is a paying donor and another of the plurality of donors is an associate donor, and
wherein receiving electronic donations comprises receiving electronic donations from the paying donor on behalf of the associate donor at the time interval associated with the paying and associate donors.

29. The method of claim 27, wherein the donors are members of a private donation group.

30. The method of claim 27, wherein the donors are members of a public donation group.

31. The method of claim 27, wherein the time period is a monthly time period.

32. A method for providing network-based management of donations comprising:
maintaining a database defining an organization that includes a plurality of programs;
presenting a user interface to specify one or more of the plurality of programs as beneficiaries of a donation group; and
receiving electronic donations to the one or more specified programs from donors that are members of the donation group via a computer network.

33. The method of claim 32, further comprising:
maintaining the database to define a plurality of sub-programs,
wherein the plurality of sub-programs are associated with one of the plurality of programs within the database, and
wherein presenting the user interface includes presenting the user interface to specify the plurality of sub-programs as beneficiaries of the donation group.

34. The method of claim 32, further comprising:
storing matching data associated with one of the programs; and
automatically transacting an electronic donation to the associated program to match an electronic donation received from one of the donors.

35. The method of claim 32, wherein the donation group includes a private donation group.

36. The method of claim 32, wherein the donation group includes a public donation group.

37. The method of claim 32,
wherein donors comprise an associate donor and a paying donor that makes donations on behalf of the associate donor, and
wherein receiving electronic donations comprises receiving the electronic donations to the one or more specified programs from the paying donor on behalf of the associate donor via the computer network.

38. The method of claim 32, wherein an organization includes one of a university, a school, a church, a charity, an association and a hospital.

39. A donation management system comprising:
a group manager module to present a user interface to receive input to create a private donation group; and
a donation manager module to receive electronic donations to the private donation group via a computer network.

40. The system of claim 39, wherein the user interface is a first user interface and the method further comprises a template manager module to present a second user interface to configure an electronic invitation, wherein the group manager module requires a donor to accept the electronic invitation to become a member of the private donation group.

41. The system of claim 40,
wherein the template manager further issues the electronic invitation from a member donor of the private donation group to the donor, and
wherein the group manager presents a third user interface to receive a selection from the donor to join the private donation group.

42. The system of claim 39,
wherein the user interface is a first user interface, and
wherein the group manager module presents a second user interface to only present information associated with the private donation group to a donor that is a member of the private donation group.

43. The system of claim 42, wherein the information associated with the private donation group includes one or more of a total amount invited per member of the private donation group, a total amount donated per member of the private donation group, and a list of members of the private donation group.

44. The system of claim 39,
wherein the user interface is a first user interface,
wherein the group manager module presents a second user interface to receive input to create a public donation group, and
wherein the donation manager module further receives electronic donations to the public donation group via the computer network.

45. The system of claim 39, further comprising:
one or more databases to store information associated with the private donation group and the electronic donations; and
a user interface to receive input identifying a first portion of the information as private and a second portion as public.

46. A donation management system comprising:
a donor manager module to present a user interface to specify a paying donor that makes electronic donations on behalf of an associate donor; and
a donation manager module to receive the electronic donations from the paying donor on behalf of the associate donor via a computer network.

47. The system of claim 46, wherein the user interface comprises one or more donor invite inputs to specify the paying donor.

48. The system of claim 47, wherein the donor manager module communicates with the paying donor to receive permission from the paying donor to make the electronic donations on behalf of the associate donor in response to information entered into the one or more donor invite inputs.

49. The system of claim 48, wherein the donor manager module communicates with the paying donor by sending electronic mail to the paying donor.

50. The system of claim 46,
wherein the user interface is a first user interface, and
wherein the donor manager module further presents a second user interface to specify the associate donor, wherein the second user interface comprises associate donor invite inputs to specify the associate donor.

51. The system of claim 50, wherein the donor manager module further communicates with the associate donor to receive permission from the associate donor to allow the paying donor to make the electronic donations on behalf of the associate donor in response to information entered into the one or more associate donor invite inputs.

52. The system of claim 51, wherein the donor manager module communicates with the associate donor by sending electronic mail to the associate donor.

53. The system of claim 50, wherein the first and second user interfaces are the same user interface.

54. The system of claim 46, wherein the donor manager module requires permission from both the paying donor and the associate donor prior to allowing the paying donor to make the electronic donations on behalf of the associate donor.

55. The system of claim 46, further comprising one or more databases to store information associated with the paying donor, the associate donor, and the electronic donations.

56. A donation management system comprising:
one or more databases to store data that defines a donation group having one or more donors, wherein the database stores invite data that specifies for each of the donors a total dollar amount donated by other donors in response to an electronic invitation by the respective donor; and
a group manager module to present a user interface to display the invite data for each of the donors of the donation group.

57. The system of claim 56, wherein the one or more of other donors includes the one or more donors included within the donation group and donors that are included within other donation groups.

58. The system of claim 56, further comprising a template manager module to send the electronic invitation from one of the one or more donors to one or more other donors to invite the one or more other donors to join the donation group.

59. The system of claim 58,
wherein the user interface is a first user interface, and
wherein the group manager module presents a second user interface to receive a response from each of the one or more other donors that receive the electronic invitation and adds the one or more other donors to the donation group based on each response.

60. The system of claim 56, wherein the donation group includes a private donation group that requires the one or more other donors to accept the electronic invitation to join the group.

61. The system of claim 56, wherein the donation group includes a public donation group.

62. The system of claim 56, wherein the user interface further displays one or more of a total amount donated, a member donor name, a member donor city, and a member donor state.

63. A donation management system comprising:
one or more databases to define a plurality of donors and a plurality of donation intervals over a time period;
a donor manager module to present a user interface to associate at least one of the plurality of donors with each of the plurality of donation intervals; and
a donation manager module to receive electronic donations from each of the plurality of donors at the donation interval associated with the respective donor.

64. The system of claim 63,
wherein one of the plurality of donors is a paying donor and another of the plurality of donors is an associate donor, and
wherein the donation manager module receives electronic donations from the paying donor on behalf of the associate donor at the time interval associated with the paying and associate donors.

65. The system of claim 63, wherein the plurality of donors are members of a private donation group.

66. The system of claim 63, wherein the plurality of donors are members of a public donation group.

67. The system of claim 63, wherein the time period is a monthly time period.

68. A donation management system comprising:
a database defining an organization that includes a plurality of programs;
a group manager module to present a user interface to specify one or more of the plurality of programs as beneficiaries of a donation group; and
a donation manager module to receive electronic donations to the one or more specified programs from donors that are members of the donation group via a computer network.

69. The system of claim 68,
wherein the database further defines a plurality of sub-programs, wherein the plurality of sub-programs are associated with one of the plurality of programs within the database,
wherein the group manager module presents the user interface to specify the plurality of sub-programs as beneficiaries of the donation group.

70. The system of claim 68, wherein the donation manager module contributes another electronic donation to match the electronic donations received from the donors on behalf of the donors.

71. The system of claim 68, further comprising an organization manager to present a user interface to receive organization input and update the database based on the organization input.

72. The system of claim 68, wherein the donation group includes a private donation group.

73. The system of claim 68, wherein the donation group includes a public donation group.

74. The system of claim 68,
wherein donors comprise an associate donor and a paying donor that makes donations on behalf of the associate donor, and
wherein the donation manager module further receives electronic donations to the one or more specified programs from the paying donor on behalf of the associate donor via the computer network.

75. The system of claim 68, wherein an organization includes one of a university, a school, a church, a charity, an association and a hospital.

76. An online donation management system comprising:
a web server that includes user interface modules that present user interfaces with which a plurality of organizations interact to solicit donations by creating one or more programs and with which a plurality of donors interact to create donation groups,
wherein the donors interact with the web servers to associate the donation groups with the programs and specify the donation groups as private or public donation groups; and
a database server that includes databases to store information associated with the programs and donation groups.

77. The system of claim 76, wherein user interface modules include an organization manager module that presents one of the user interfaces with which the plurality of organizations interact to solicit the donation, and a group manager module with which the plurality of donors interact to create donation groups.

78. The system of claim 76, wherein the group manager module further requires that each of the donors accept an electronic invitation before joining any of the private donation groups.

79. The system of claim 76,
wherein donation groups include at least one public donation group, and
wherein the group manager module further requires that each of the donors accept an electronic invitation before joining the at least one public donation group.

80. The system of claim 76,
wherein the plurality of donors includes an associate donor and a paying donor that makes donations on behalf of the associate donor,
wherein the user interface modules include a donor manager module to specify the paying donor and the associate donor, and
wherein the databases further store information associated with the paying donor and the associate donor.

81. The system of claim 76, wherein the user interface modules present additional user interfaces with which the plurality of donors interact to create honor groups to honor one or more individuals, wherein the honor group specifies a charity to which donations are made in honor of the one or more individuals.

82. The system of 81, wherein the additional user interface further includes additional user interfaces with which the plurality of donors interact to upload at least one of a photo, a caption, and an anecdote to the honor group.

83. A computer-readable medium for providing network-based management of donations comprising instructions for causing a programmable processor to:
present a user interface to receive input to create a private donation group; and
receive electronic donations to the private donation group via a computer network.

84. The computer-readable medium of claim 83, wherein the user interface is a first user interface and further comprising instructions for causing the programmable processor to:
present a second user interface to specify a paying donor that makes the electronic donations on behalf of an associate donor; and
receive the electronic donations from the paying donor on behalf of the associate donor via a computer network.

85. The computer-readable medium of claim 83, wherein the user interface is a first user interface and further comprising instructions for causing the programmable processor to:
maintain a database defining the private donation group that includes one or more donors, wherein the database stores invite data for each donor specifying a total dollar amount donated by one or more other donors in response to an electronic invitation by the donor; and
present a second user interface to display the invite data for each of the donors of the private donation group.

86. The computer-readable medium of claim 83, wherein the user interface is a first user interface and further comprising instructions for causing the programmable processor to:
maintain a database defining the private donation group, wherein the private donation group includes a plurality of donors and a plurality of donation intervals over a time period;
present a second user interface to associate at least one of the plurality of donors with each of the plurality of donation intervals; and
receive electronic donations to the private donation group from each of the plurality of donors at the donation interval associated with the respective donor.
